(19) United States
(12) Patent Application Publication
(10) Pub. No.: US 2015/0081507 A1
(43) Pub. Date: Mar. 19, 2015

(54) SYSTEM AND METHOD FOR PROCESSING ELECTRONIC TRADE CONFIRMATION REPORTS

(71) Applicants: Chris Sparrow, Toronto (CA); Darren Sumarah, Etobicoke (CA)

(72) Inventors: Chris Sparrow, Toronto (CA); Darren Sumarah, Etobicoke (CA)

(21) Appl. No.: 14/454,946

(22) Filed: Aug. 8, 2014

Related U.S. Application Data
(60) Provisional application No. 61/863,885, filed on Aug. 8, 2013.

(51) Int. Cl. G06Q 40/04

(52) U.S. Cl. CPC G06Q 40/04
USPC 705/37

(57) ABSTRACT

A computer-implemented method of processing electronic trade confirmation data upon execution of a trade is provided. The method includes, using a computing system, determining an execution price from the electronic trade confirmation data; using the computing system, determining at least one fee/rebate for a side of the trade; using the computing system, determining a modified execution price for the side of the trade based at least on the execution price and the at least one fee/rebate; and using the computing system, associating the modified execution price with the trade.

The present application claims priority to U.S. Provisional Patent Application No. 61/863,885, filed Aug. 8, 2013, the entirety of which is incorporated herein by reference

### FIELD OF THE INVENTION

The following relates generally to electronic data processing, and more particularly to systems and methods for processing electronic trade confirmation data produced upon execution of trades in financial markets.

### BACKGROUND OF THE INVENTION

Specialized computing systems and communications protocols that enable high-volume data processing and communications in financial markets are complex. In a given trading day, millions of electronic messages, signals and reports embodying buy orders, sell orders, change orders, trade confirmations, quotes and the like are created, modified, transmitted, relayed, received, and otherwise processed amongst electronic trading venues, venue members, buy-side managers, beneficial clients, market makers, settlement houses, custodians, investment banks and other members and participants in financial markets. These complex, highly specialized systems and processes must be highly-reliable, accurate, rapid and efficient in order to fulfill their intended functions.

Orders to buy or sell financial instruments, such as securities, bonds, derivatives and the like are typically posted to an electronic trading venue on behalf of beneficial owners by a licensed member of the trading venue, known as a venue member. The beneficial owner may be a direct client of the venue member, or may be a client of an intermediary, such as a buy-side fund manager, that is itself the client of the venue member.

Venue members route electronic orders to the appropriate trading venue for posting, and the trading venue employs matching engines to automatically execute trades by matching posted buy and sell orders. For a given trade, the side removing an order matched to an original, previously-posted order is known as the liquidity-taker, whereas the side posting that original order is known as a liquidity-maker.

The venue members that posted the matched orders each receive a respective electronic trade confirmation typically from the trading venue. A clearing house also receives a respective electronic trade confirmation. Each venue member verifies the electronic trade confirmation with the trading venue and, depending upon market rules, one venue member or both venue members forward their respective electronic trade confirmations to the clearing house. Each electronic trade confirmation typically incorporates data concerning various attributes of the trade. For example, a trade confirmation may include symbol of the financial instrument, buy or sell, quantity, execution price, liquidity flag, and trading venue.

Trading venues establish pricing models that set applicable fees or rebates for trades that are executed for venue members. Pricing models include symmetrical and asymmetrical models. At the trade level, with a symmetrical pricing model both venue members typically pay a fee to the trading venue, whereas with an asymmetrical pricing model one venue member pays a fee and the other venue member receives a rebate. Which venue member pays a fee and which venue member receives a rebate depends upon whether the particular asymmetrical pricing model being employed offers the rebate to the liquidity-maker on the trade or to the liquidity-taker. For example, according to make/take pricing, the maker receives a rebate and the taker pays a fee. According to take/make pricing, the taker receives a rebate and the maker pays a fee. Trading venue pricing models may also be structured to establish variable fees/rebates based on a venue member's overall average trading volume or other factors as determined by the trading venue.

Each trading venue tracks trades executed over a given billing period, such as a month. At the end of the billing period the trading venue reports to each venue member only a respective aggregate fee/rebate amount that is owed by that venue member to the trading venue according to the applicable pricing model and the venue member's trading activity. The aggregate fee/rebate is treated by the venue member as an expense, and the expense is generally considered covered by the commissions the venue member charges to its clients, for example the buy-side managers. However, because the venue member and the buy-side managers are ultimately fiduciaries of the beneficial owner, it could be argued that they should be passing individual trade-level fees as well as rebates along to the beneficial owners.

A technical difficulty arises for the venue members however in passing individual fees or rebates to beneficial owners. This is primarily because, as only the aggregate fee/rebate is reported by the trading venue, the individual trade-level fees or rebates that were combined to form it are individually irretrievable from the aggregate by the venue member or any other downstream systems. The aggregate fee/rebate is simply not granular enough to enable accurate allocations to beneficial owners. The venue member therefore receives rebates subsumed in the aggregate fee/rebate that cannot be fairly divided out and passed on to the buy-side managers so they may be allocated to the beneficial owners. This technical difficulty creates a potential for conflict between the buy-side manager and the venue member: the venue member, by potentially receiving rebates it cannot technically pass along, has an incentive to route orders based on trading venue rebates rather than based on best liquidity for the beneficial owner. Even if the entire aggregate fee/rebate is able to be passed back to a buy-side manager thus alleviating the venue member's conflict, the conflict simply shifts to between the buy-side manager and the beneficial owner. This is because the buy-side manager is similarly unable to properly allocate individual fee/rebates to the individual beneficial owners that it services. As a result of this technical limitation, the venue members and buy-side managers are generally failing to pass back trading venue rebates to the beneficial owners and failing to receive from the beneficial owners trading venue fees.

With symmetrical pricing no rebates are paid such that the beneficial owner may be roughly passed the payable fees through proper application of commissions and service fees passed from the venue member to the beneficial owners. However, such commissions and services fees cannot work in the same way to pass rebates to beneficial owners, so the problem is particularly difficult where asymmetrical pricing models are being employed.

To compound the problem, buy-side manager legacy computing systems adapted to process a specific format of trade confirmation report relayed by the venue member are often not capable of receiving or reconciling any additional electronic messages incorporating additional data respecting the particular trade, such as any trading venue fees/rebates applicable to the trade. As result, the venue member is confronted with a further technical barrier to electronically transmitting data about individual fees/rebates, should it even have such information, to the buy-side managers.

In an effort to compensate for the technological barriers described above, some buy-side managers may have an arrangement whereby a portion of an aggregate trading venue fee/rebate incurred in a given month is passed along to the client by way of incorporation into a monthly invoice. However, several conflicts persist through such arrangements because the venue member is not receiving trade-level fee/rebate information.

### SUMMARY OF THE INVENTION

In accordance with an aspect, there is provided a computer-implemented method for processing electronic trade confirmation data generated by at least a first server computer upon execution of a trade in a data processing system comprising at least a second specifically programmed server computer coupled over a communications network to the first server computer, the method comprising: using the second server computer, determining an execution price from the electronic trade confirmation data generated by the first server computer; using the second server computer, determining at least one fee/rebate for a side of the trade; using the second server computer, determining a modified execution price for the side of the trade based at least on the execution price and the at least one fee/rebate; and using the second server computer, associating the modified execution price with the trade in data store stored on a persistent memory accessible by the second server computer.

The electronic trade confirmation data may be determined from an either transitory or non-transitory electronic trade confirmation report that incorporates or refers to data concerning the trade, including the execution price (i.e. the trading venue clearing price) of the trade.

By determining a modified execution price based at least on the execution price and the at least one fee/rebate that is determined to be applicable to the trade, the at least one fee/rebate may be allocated to the beneficial owner on a trade-by-trade basis by way of being passed to the beneficial owner via the modified execution price. Because the beneficial owner is allocated the fee/rebate on a trade-by-trade basis, the venue member and the buy-side manager are technically enabled to pass on the fee/rebate to the beneficial owner. This deals with the conflict between the venue member and the buy-side manager, and between the buy-side manager and the beneficial owner.

In an embodiment, a modified electronic trade confirmation report incorporating the modified execution price in lieu of the execution price is produced and may be transmitted downstream to, for example, a buy-side manager system. The buy-side manager system is able to handle the modified electronic trade confirmation report as it had previously handled an incoming electronic trade confirmation report without necessarily requiring additional modifications to its legacy systems.

In an embodiment, determining the modified execution price comprises calculating a sum of, or difference between, the execution price and the at least one fee/rebate. In another embodiment, determining the modified execution price comprises calculating a sum of, or difference between, the execution price and an estimate of the at least one fee/rebate. In another embodiment, determining the modified execution price comprises calculating a sum of, or difference between, the execution price and a portion of the at least one fee/rebate.

In an embodiment, during a billing period, payments are accrued based on modified execution prices that are received from, or sent to, beneficial owners for trades executed and, after the billing period, accrued payments are balanced against an aggregate fee/rebate applied by the trading venue and the execution prices of trades executed during the trading period.

In an embodiment, payments received from, and sent to, beneficial owners are received from, and sent to, respective representatives of the beneficial owners.

In an embodiment, payments received incorporate commission amounts, and the balancing comprises balancing the accrued payments, less the commission amounts, against the aggregate fee/rebate.

In an embodiment, the electronic trade confirmation data is determined from an electronic trade confirmation report. In an embodiment, associating the modified execution price with the trade comprises producing a modified electronic trade confirmation report incorporating the modified execution price.

In an embodiment, both the electronic trade confirmation report and the modified execution price are transmitted to at least one downstream system. In an embodiment, the electronic trade confirmation report and the modified execution price are transmitted to respective, different downstream systems.

In an embodiment, producing the modified electronic trade confirmation report comprises creating a copy of the electronic trade confirmation report and replacing the execution price in the copy with the modified execution price. In another embodiment, producing the modified electronic trade confirmation report comprises replacing the execution price in the electronic trade confirmation report with the modified execution price.

In an embodiment, the modified execution price is incorporated in a modified electronic trade confirmation report. In an embodiment, the modified electronic trade confirmation report incorporates a different number of attributes of the trade than does the electronic trade confirmation report. In another embodiment, the modified electronic trade confirmation report incorporates only the modified execution price and an identifier uniquely identifying the electronic trade confirmation report. In an embodiment, the identifier is an order identifier uniquely identifying the order that was filled by the trade.

According to another aspect, there is provided a non-transitory computer readable medium embodying a computer program executable on a computing system for processing electronic trade confirmation data upon execution of a trade, the computer program comprising computer program code for determining an execution price from the electronic trade confirmation data; computer program code for determining at least one fee/rebate for a side of the trade; computer program code for determining a modified execution price for the side of the trade based at least on the execution price and the at least one fee/rebate; and computer program code for associating the modified execution price with the trade.

According to another aspect, there is provided a computing system comprising at least one processor executing instructions for processing electronic trade confirmation data upon execution of a trade, the at least one processor configured therewith to determine an execution price and associate with the trade a modified execution price determined based on the execution price and at least one fee/rebate applicable to the trade.

The computing system may be incorporated as part of one or more larger systems, such as an order management system, a direct market access system, an execution management system, an algorithmic trading platform, a middle-office settlement system, or a prime brokerage system. The computing system may be incorporated as part of a trading venue.

According to another aspect, there is provided a non-transitory computer readable medium embodying a computer program executable on a computing system for processing electronic trade confirmation data upon execution of a trade to determine an execution price and associating with the trade a modified execution price determined based on the execution price and at least one fee/rebate applicable to the trade.

### BRIEF DESCRIPTION OF THE DRAWING

Embodiments of the invention will now be described with reference to the appended drawings in which:

FIG. 1 is a schematic diagram showing a flow of electronic information in a trade settlement process implemented in a networked computing environment;

FIG. 2A is a schematic diagram showing a flow of electronic information in a trade settlement process implemented in a networked computing environment for processing an electronic trade confirmation report on two sides of a trade, according to an embodiment;

FIG. 2B is a schematic diagram showing a flow of electronic information in a trade settlement process implemented in a networked computing environment for processing an electronic trade confirmation report on only one side of a trade, according to an embodiment;

FIG. 3A is a schematic diagram showing a flow of electronic information in an alternative trade settlement process implemented in a networked computing environment processing an electronic trade confirmation report on two sides of a trade by or at the direction of the trading venue, according to an embodiment;

FIG. 3B is a schematic diagram showing a flow of electronic information in the alternative trade settlement process implemented in a networked computing environment processing an electronic trade confirmation report on only one side of a trade at the direction of the trading venue, according to an embodiment;

FIG. 3C is a schematic diagram showing a flow of electronic information in the alternative trade settlement process implemented in a networked computing environment processing an electronic trade confirmation report on one side of a trade by or at the direction of the trading venue and on the other side of the trade by or at the direction of a venue member, according to an embodiment;

FIG. 4 is a flow chart depicting steps in a computer-implemented method of processing an electronic trade confirmation report, according to an embodiment;

FIG. 5 is a schematic diagram of an aspect of the computing environment which may be used to implement on or more embodiments of the method;

FIG. 6 is a representation of an electronic trade confirmation report produced by a trading venue for a liquidity-taker buyer, according to an embodiment;

FIG. 7 is a representation of a pricing schedule with consolidated trading venue pricing, according to an embodiment;

FIG. 8 is a representation of a consolidated order book incorporating orders from multiple venues, according to an embodiment;

FIG. 9 is a representation of a modified electronic trade confirmation report produced for the liquidity-taker buyer based on the execution price of the electronic trade confirmation report of FIG. 6 and an applicable fee/rebate, according to an embodiment;

FIG. 10 is a representation of an electronic trade confirmation report produced by the trading venue for a liquidity-maker seller, according to an embodiment;

FIG. 11 is a representation of a modified electronic trade confirmation report produced for the liquidity-maker seller based on the execution price of the electronic trade confirmation report of FIG. 10 and an applicable fee/rebate, according to an embodiment;

FIG. 12 depicts a table having multiple electronic trade confirmation reports;

FIG. 13 lists computer-readable program code that is storable in a non-transitory computer-readable medium establishing a function having hardcoded example fee schedules; and

FIG. 14 lists computer-readable program code that is storable in a non-transitory computer-readable medium establishing a function for retrieving a .csv file containing the electronic trade confirmation reports depicted in FIG. 12.

### DETAILED DESCRIPTION

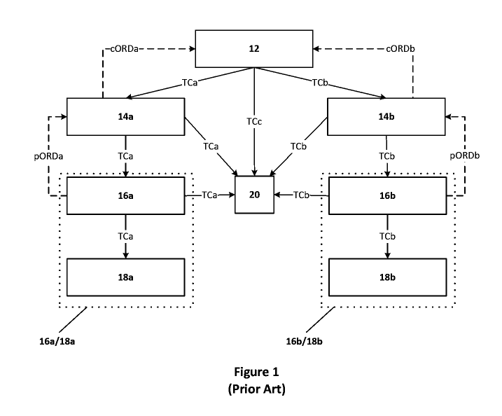

FIG. 1 is a schematic diagram showing a flow of electronic information in a basic trade settlement process implemented in a networked computing environment. In this arrangement, a trading venue 12 has, amongst its members, venue members 14a and 14b. A buy-side manager 16a is a client of venue member 14a. In this arrangement, there is also a beneficial owner 18a who is, in turn, is a client of buy-side manager 16a. Similarly, a buy-side manager 16b is a client of venue member 14b. Beneficial owner 18b is, in turn, a client of buy-side manager 16b. A clearing house 20 is available for clearing trades.

Each of the entities described above, and others, include special purpose, specifically programmed client computers and server computers coupled to each other for facilitating communications via a wired or wireless communications network such as a local area network, wide area network, the Internet or other proprietary or publicly-accessible networks. For the sake of brevity, these computers are referred to herein by entity name. For example, trading venue 12 refers to one or more trading venue computers, e.g., server computers. Similarly, venue members 14a and 14b refers to one or more venue member computers, e.g., servers and/or client computers etc. Communications between the client and server computers, particularly when traversing one or more publicly-accessible networks, are preferably encrypted to ensure the security of the information incorporated therein.

To initiate, the buy-side manager 16a places a parent order pORDa with venue member 14a based on instructions from beneficial owner 18a. Venue member 14a subsequently posts a child order cORDa at trading venue 12. Similarly, venue member 14b posts a child order cORDb at trading venue 12 on behalf of beneficial owner 18b.

In the process depicted in FIG. 1, child orders cORDa and cORDb are matched by a matching engine at trading venue 12, which then produces electronic trade confirmation reports TCa, TCb and TCc for venue member 14a, venue member 14b, and clearing house 20, respectively. Electronic trade confirmation reports contain electronic trade confirmation data specific to the trade and trading venue. Because venue member 14a posted the order cORDa that was later filled by venue member 14b's later-posted order cORDb, a liquidity field in electronic trade confirmation report TCa for venue member 14a includes a value that indicates liquidity-maker, whereas the liquidity field in electronic trade confirmation report TCb for venue member 14b includes a value that indicates liquidity-taker.

Electronic trade confirmation report TCa is passed by venue member 14a to both buy-side manager 16a and clearing house 20. Electronic trade confirmation report TCa is, in turn, passed by buy-side manager 16a to both beneficial owner 18a and clearing house 20.

Similarly, electronic trade confirmation report TCb is passed by venue member 14b to buy-side manager 16b and the clearing house 20, and the electronic trade confirmation report TCb is, in turn, passed by the buy-side manager 16b to both beneficial owner 18b and clearing house 20. Clearing house 20 manages clearing the trades.

It can be seen that, in the process depicted in FIG. 1, the beneficial owners 18a, 18b receive respective electronic trade confirmation reports TCa, TCb that each incorporate the execution price as cleared (i.e., clearing price). As the electronic trading venue 12 has not provided information about any trading venue fee/rebates at this trade level, the beneficial owners 18a, 18b receive no information regarding the trading venue fee/rebates at the trade level. The beneficial owners 18a, 18b therefore are not able to determine from the report the true price of the trade.

It will be understood that various alternative arrangements of parties in a market may exist. For example, an arrangement may exist in which the buy-side manager 16a trades on its own behalf, either on the trade in question or on all trades it handles. In such an arrangement, the buy-side manager 16a would not pass an electronic trade confirmation report outside of itself and on to a beneficial owner client 18a due to the buy-side manager 16a being, in effect, the beneficial owner 18a. This could be the case on one side of the trade or on both sides, as depicted generally using the dotted-line box 16a/18a

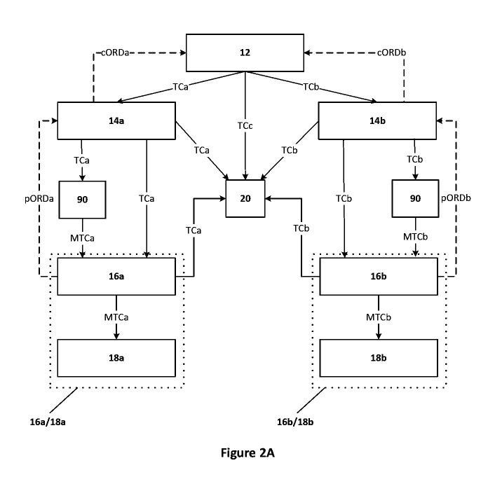

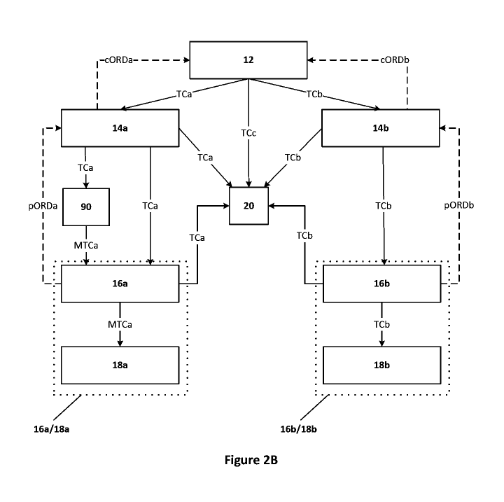

Turning now to FIG. 2A, there is shown a schematic diagram showing a flow of electronic information in a trade settlement process implemented in a networked computing environment for processing electronic trade confirmation data that may be determined from an electronic trade confirmation report, according to an embodiment. The trade settlement process in this embodiment is similar to that shown in FIG. 1 and described above. However, in this embodiment, after the venue member 14a receives the electronic trade confirmation report TCa from trading venue 12, for example, at least a first server computer, the electronic trade confirmation report TCa is subjected to processing by one or more computing devices 90, for example, at least a second server computer, in order to determine the electronic trade confirmation data and produce a modified trade confirmation report MTCa incorporating a modified execution price determined based at least on the execution price in the electronic trade confirmation report TCa and a trading venue fee/rebate that is determined to be applicable to the trade. The modified electronic trade confirmation report MTCa is provided downstream to the buy-side manager 16a for use in allocating the trading venue fee/rebate to beneficial owner 18a (and/or for its own use) through the modified execution price.

In this scenario, the electronic trade confirmation report TCb is also subjected to processing by one or more computing devices 90 (hereinafter referred to as “process 90”) in order to produce a modified electronic trade confirmation report MTCb incorporating a modified execution price based at least on the execution price determined from the electronic trade confirmation report TCb and a trading venue fee/rebate that is determined to be applicable to the trade. The modified electronic trade confirmation report MTCb is provided downstream to the buy-side manager 16b for use in allocating the trading venue fee/rebate to beneficial owner 18b (and/or for its own use) through the respective modified execution price.

While, in the scenario described above, processing by the one or more computing devices 90 has been independently executed for the benefit of both the buyer side and the seller side, this is not required. For example, processing by the one or more computing devices 90 could be executed for the benefit of only one side of the trade. Such a scenario is depicted in FIG. 2B, in which process 90 is executed downstream from venue member 14a, but not executed downstream from venue member 14b.

Each venue member 14a, 14b receives its respective electronic trade confirmation reports TCa, TCb and stores, for further use, data incorporated in the respective electronic trade confirmation reports as an electronic trade confirmation report. The electronic trade confirmation report may be held as a record in persistent memory such as in a database or other data store on a hard disk, held in random access memory, or otherwise made available for further use. The electronic trade confirmation report may be held in exactly the same form as the received electronic trade confirmation report or may be re-formatted in some manner to suit processing or the technical requirements of the venue member system or other system handling the processing.

The venue members 14a, 14b typically each execute a standard computer implemented process of confirming that the received electronic trade confirmation data is proper, such as ensuring it correlates properly to the order cORDa, cORDb that the venue member 14a, 14b has record of posting. For example, the venue member 14a, 14b may store an electronic order record. Forwarding the electronic trade confirmation report TCa also to the buy-side manager 16a is part of the confirmation process, as the buy-side manager 16a is able to provide confirmation of the correctness of the trade.

During clearing, the clearing house 20 executes a standard computer implemented process for clearing the trade, and settlement is thereafter handled in a known manner.

The computer implemented process by devices(s) 90 can be executed at any time after the trade has been executed, for example at a point downstream from the trading venue 12 and upstream from the beneficial owner 18a. As such, the process 90 may be executed by one or more venue member systems (or one or more systems overseen by venue members 14a/14b) receiving its respective electronic trade confirmation report TCa/TCb, or may be conducted by another system either downstream from, or receiving the electronic trade confirmation report TCa/TCb in parallel to, the venue member 14a/14b responsible for handling the trade for the beneficial owner 18a/18b. For example, the process 90 may be conducted at an order management system, at a direct market access system, at an execution management system, at an algorithmic trading platform, at a middle-office settlement system, at a prime brokerage system, or at some other suitable point.

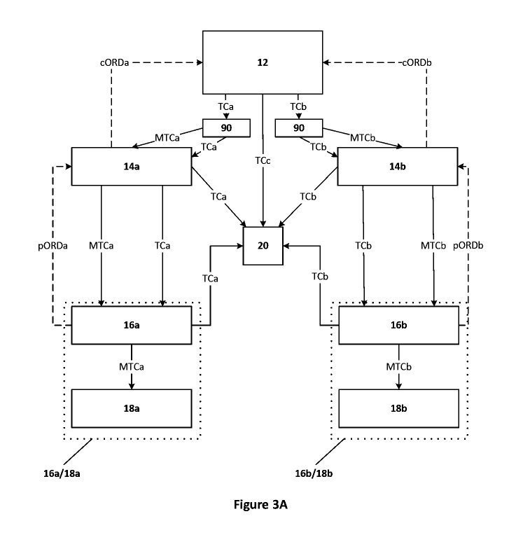

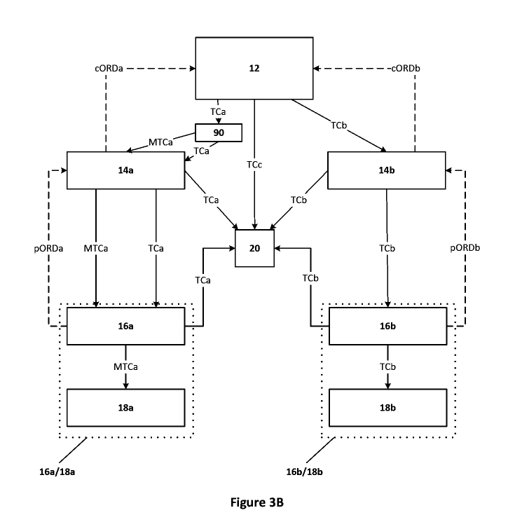

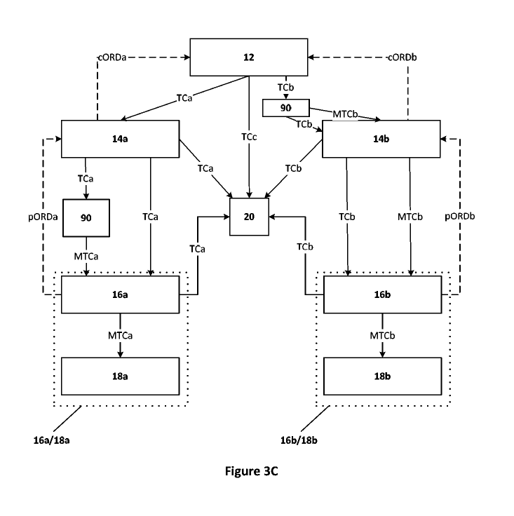

In an alternative embodiment, the process 90 may be executed at the trading venue 12 by being incorporated into a trading venue system (or otherwise at the direction of the trading venue 12), at a point during the trade settlement process that enables the modified electronic trade confirmation reports MTCa, MTCb to be provided to respective venue members 14a, 14b along with (or instead of) the electronic trade confirmation reports TCa, TCb. FIG. 3A is a schematic diagram depicting a flow of electronic information in such an alternative trade settlement process implemented in a networked computing environment. The modified trade confirmation reports MTCa, MTCb may be provided before, at the same time, or after the electronic trade confirmation report TCa, TCb. In fact, in one embodiment the trading venue 12 does not produce electronic trade confirmation reports that are subsequently modified, but simply operates on electronic trade confirmation data to produce a modified price that can subsequently be included as part of an electronic trade confirmation report TCa or TCb.

Furthermore, the trading venue 12 may choose to selectively produce modified electronic trade confirmation report MTCa for provision to venue member 14a but not produce modified electronic trade confirmation report MTCb for provision to venue member 14b (or vice versa), due to differences in membership levels between venue member 14a and venue member 14b, or some other factor. FIG. 3B is a schematic diagram depicting a flow of electronic information in such an alternative scenario implemented in a networked computing environment, in which process 90 is executed for the benefit of venue member 14a and those downstream from venue member 14a, but not executed for the benefit of venue member 14b and those downstream from venue member 14b.

In one scenario venue member 14a could first implement process 90 for itself and then, at a later time—perhaps even years later—trading venue 12 could implement process 90, to provide the benefit to all of its venue members. Venue member 14a already having implemented process 90 to produce modified electronic trade confirmation reports MTCa for itself may negotiate temporarily or permanently opting-out of receiving such modified trade confirmation reports MTCa from trading venue 12. FIG. 3C is a schematic diagram depicting such an alternative scenario, in which process 90 is executed by or at the direction of trading venue 12 for the benefit of venue member 14b and those downstream from venue member 14b, but not executed by or at the direction of trading venue 12 for the benefit of venue member 14a and those downstream from venue member 14a. Rather, venue member 14a executes process 90 for its own benefit and the benefit of those downstream from venue member 14a.

In another scenario a venue member such as venue member 14a could decide to start implementing process 90 for itself, even if trading venue 12 had long been able to produce the modified trade confirmation reports MTCa for venue members. As an example, venue member 14a may choose to do this if it has determined that it is more cost-effective, more controllable or quicker to implement process 90 on its own to produce its own modified trade confirmations MTCa, rather than rely on trading venue 12 to produce them.

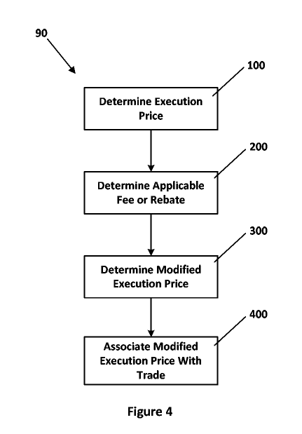

FIG. 4 is a flowchart of the process 90, according to an embodiment. During processing of the electronic trade confirmation data, generally an execution price (i.e., “clearing” price) is determined from the electronic trade confirmation data (step 100), at least one fee/rebate applicable to the trade is determined (step 200), a modified execution price is determined based at least on the execution price and the at least one fee/rebate (step 300), and the modified execution price is then associated with the trade (step 400).

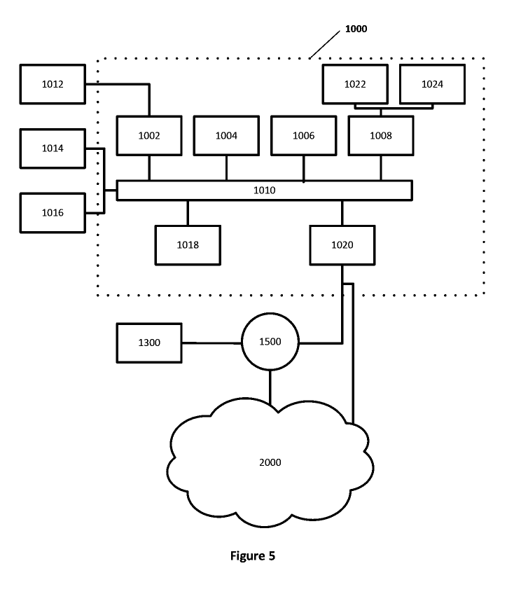

In this embodiment, process 90 is executed on a special purpose computing system 1000 such as that shown in FIG. 5. The computing system 1000 may be incorporated into an order management system, a direct market access system, an execution management system, an algorithmic trading platform, a middle-office settlement system, a prime brokerage system, or other system between a trading venue and the beneficial owners of trades.

Computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables or other intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

The computing system 1000 also includes a disk controller 1008 coupled to the bus 1010 to control one or more storage devices for storing information and instructions, such as a magnetic hard disk 1022, and a removable media drive 1024 (e.g., floppy disk drive, read-only compact disc drive, read/write compact disc drive, compact disc jukebox, tape drive, and removable magneto-optical drive). The storage devices may be added to the computing system 1000 using an appropriate device interface (e.g., small computing system interface (SCSI), integrated device electronics (IDE), enhanced-IDE (E-IDE), direct memory access (DMA), or ultra-DMA).

The computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computing system 1000 may also include a display controller 1002 coupled to the bus 1010 to control a display 1012, such as a liquid crystal display (LCD) screen, for displaying information to a computer user. The computing system 1000 includes input devices, such as a keyboard 1014 and a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. In addition, a printer may provide printed listings of data stored and/or generated by the computing system 1000.

The computing system 1000 performs a portion or all of the processing steps discussed herein in response to the processor 1018 executing one or more sequences of one or more instructions contained in a memory, such as the main memory 1004. Such instructions may be read into the main memory 1004 from another computer readable medium, such as a hard disk 1022 or a removable media drive 1024. One or more processors in a multi-processing arrangement may also be employed to execute the sequences of instructions contained in main memory 1004. In alternative embodiments, hard-wired circuitry may be used in place of or in combination with software instructions.

As stated above, the computing system 1000 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, includes software for controlling the computing system 1000, for driving a device or devices to perform the functions discussed herein, and for enabling the computing system 1000 to interact with a human user (e.g., print production personnel). Such software may include, but is not limited to, device drivers, operating systems, development tools, and applications software. Such computer readable media further includes the computer program product for performing all or a portion (if processing is distributed) of the processing performed discussed herein.

The computer code devices of discussed herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A computer readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications.

Various forms of computer readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computing system 1000 may receive the data on the telephone line and use an infrared transmitter to convert the data to an infrared signal. An infrared detector coupled to the bus 1010 can receive the data carried in the infrared signal and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

The computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information depicted in FIGS. 2A-3C. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc). The signals through the various networks and the signals on the network link and through the communication interface 1020, which carry the digital data to and from the computing system 1000 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA) laptop computer, or cellular telephone.

Alternative configurations of computing system 1000, such as those that are not interacted with directly by a human user through a graphical or text user interface, may be used to implement process 90.

While various trade-related messaging protocols are known, further details of the above steps according to one embodiment will be described below in terms of messages and fields formatted according to Financial Information eXchange (“FIX”) Protocol, Version 4.2. It will be understood by a skilled reader that a different implementation could alternatively employ a different version of FIX, could employ one or more different protocols for its messaging and field formats, or could involve fewer or more fields or messages for determining a modified execution price based at least on the execution price and at least one fee/rebate applicable to the trade. Such slight modifications may be made without departing from the spirit, purpose and scope of the invention disclosed herein.

In this embodiment, the electronic trade confirmation report pushed by the trading venue computer (s) and in which the electronic trade confirmation data is incorporated is otherwise known as an Execution Report (FIX MsgType=8) where tag (or “field”) 39 has a value of either 1 (order partially filled) or 2 (order filled). This electronic trade confirmation report is pushed by the trading venue computer (s) in an ASCII format or another text format, with several individual fields separated from each other by a <start of header> character. Among other fields, the electronic trade confirmation report includes an OrderID (field 11), a venue of execution (field 30), an execution price otherwise known as an “average” price (field 6), a financial product symbol (in field 55 or both fields 55 and 65) such as a stock symbol, liquidity flags (field 851 LastLiquidityInd), and the side of the order (field 54) such as buy or sell or short.

In this embodiment, the execution price is determined from field 6 in the Execution Report. This may be done by the computer system parsing the text of the electronic trade execution report directly to retrieve the value of field 6, retrieving the value of field 6 that has been stored as part of a record in a corresponding field in a data store such as a database or table based on the text of the electronic trade execution report, or some other known technique.

There are several additional fields in a typical electronic trade confirmation report, many of which may be used for determining the fee/rebate.

In this description, a fee/rebate is a fee if it has a zero value or a positive value such as 0.0025 cents, and is a rebate if it has a negative value such as −0.0025 cents. For ease of understanding, the fee/rebate described in the following is a single fee/rebate considered by a trading venue computer(s) to be applicable to the trade. However, it will be understood that the fee/rebate applicable to the trade may alternatively be based on one, several or all of multiple fees/rebates considered by the trading venue computer(s) to be applicable to the trade.

In this embodiment, during determining the fee/rebate applicable to the trade, it the computer system first determines whether there is a fee/rebate applicable to the trade. For example, the venue member system or other downstream system processing the electronic trade confirmation reports may choose not to pass to beneficial owners a trading venue fee/rebate in a particular instance. In such a case the modified execution price will be determined to be equal to the execution price. Alternatively, in the event that the liquidity flag(s) in the electronic trade confirmation report is (are) blank or otherwise not indicative of whether the side of the trade receiving the electronic trade confirmation report was liquidity maker or liquidity taker in the trade, either a flat fee or rebate is set, or no fee/rebate is applicable to the trade.

One of these options may be selected by the venue member computer system or other downstream computer system in accordance with internal policies, regulations or relationships with beneficial owners. In the latter instance, where no fee/rebate is considered applicable to the trade, the fee/rebate is either set at zero causing the modified execution price to be calculated as equal to the execution price, or no calculation is done and the modified execution price is simply set at the execution price.

In this embodiment, in the event that it is determined by the computer system that a fee/rebate is applicable to the trade, the particular fee/rebate is determined by first determining one or more attributes of the trade from the electronic trade confirmation report and determining the at least one fee/rebate based on the one or more attributes of the trade.

In this embodiment, multiple attributes of the trade are used as a basis for determining the at least one fee/rebate applicable to the trade. These include: the venue of execution (field 30) identifying the trading venue, and the liquidity flags (field 851) indicating liquidity maker or liquidity taker.

The fee/rebate applicable to the trade is, in this embodiment, retrieved from an electronic data store based on an association in the data store with the attributes of the trade. The electronic data store may be one or more of a table, an array, a database, a structured data file, an XML file, or some other functional data store, such as hard disk 1022 or removable media 1024. In another embodiment, the fee/rebate applicable to the trade is included by the venue 12 in a field of the electronic trade confirmation report itself, or in a subsequent report from the venue 12 that can be matched to the electronic trade confirmation report. In such an arrangement, the venue member computer system receiving this information in the electronic trade confirmation report could immediately calculate the modified execution price without referring to another electronic data store, and a modified electronic trade confirmation report would not necessarily be required.

The electronic data store embodies a data structure which is, in this embodiment, a table that includes fee/rebates of various trading venues, each with respective fees/rebates for liquidity maker and liquidity taker. A representation of a pricing schedule with consolidated trading venue pricing, according to an embodiment, is shown in FIG. 7. While not included in FIG. 7 for the sake of simplicity, it will be understood that a trading venue pricing schedule may also incorporate tiers of fees that are applicable depending on overall volume of trades executed during a given trading period, for example during a given month.

In this embodiment, determining the modified execution price includes calculating a sum of, or difference between, the execution price and the fee/rebate as applied on a per-share basis. Whether the calculation is a sum or a difference is based on whether the side of the trade for whom the electronic trade confirmation is produced by the trading venue is the buyer or the seller.

For example, in the event that the side of the trade for whom the electronic trade confirmation report is produced by the trading venue computer system for the buyer, determining the modified execution price includes calculating the sum of the execution price and the fee/rebate applicable to the trade. In this event, should the fee/rebate applicable to the trade be a rebate, then the modified execution price will have a lower amount than the execution price due to the rebate amount being less than zero.

Similarly, in the event that the side of the trade for whom the electronic trade confirmation report is produced by the trading venue computer system for the seller, determining the modified execution price includes calculating the difference of the execution price and the fee/rebate applicable to the trade (i.e., by subtracting the fee/rebate applicable to the trade from the execution price). In this event, should the fee/rebate applicable to the trade be a rebate, the modified execution price will have a higher amount than the execution price due to the rebate amount being less than zero.

One or more additional price modifiers may be determined as applicable to the trade and the modified execution price may be determined based also on the one or more additional price modifiers. Such additional price modifiers may be at least one of the charges selected from the group consisting of: a market data fee, a regulatory monitoring fee, a clearing fee, a connectivity fee, a tax, or some other applicable charge. The charge is added to the modified execution price that was determined based on the fee/rebate applicable to the trade.

In this embodiment, the modified execution price is associated with the trade by the computer system by producing a modified electronic trade confirmation report that incorporates the modified execution price. This is done by creating an electronic copy of the electronic trade confirmation report and replacing the execution price in the electronic copy with the modified execution price. Furthermore, in this embodiment the modified execution price is incorporated in the modified electronic trade confirmation in lieu of the execution price that was received in the electronic trade confirmation from the trading venue by incorporating the modified execution price in the execution price field of the modified execution confirmation report. One advantage of this approach is that downstream systems, such as buy-side manager systems, do not have to modify the internal workflows programmed into their system in order to have the modified execution prices (which account for trading venue fee/rebates on a trade-by-trade basis) automatically allocated to the beneficial owners.

With the modified execution price having been determined and associated with the trade, the modified execution price is transmitted by the system to a downstream system such as the buy-side manager system so that the fee/rebate on which the price modification is based may be allocated to the beneficial owner. The modified execution price may be transmitted in real-time or as part of a batch of modified execution prices for respective trades to be transmitted periodically to the respective computer(s) in the networked computing environment, such as those shown in FIGS. 2A-3C herein.

The modified execution price may be transmitted as part of a modified trade confirmation report or otherwise. Both the modified electronic trade confirmation report and the electronic trade confirmation report may be transmitted to one or more downstream systems, such as the buy-side manager system and/or directly to the beneficial owner. As described above, the electronic trade confirmation report is transmitted to the clearing house for handling street side clearance and settlement. However, the modified trade execution report is not required to be transmitted to the clearing house because the clearing house handles clearing based only on the execution price, and not on the modified execution price.

The modified electronic trade confirmation report may be transmitted by the system to at least one downstream system pursuant to transmitting the electronic trade confirmation, so as to update the previously-transmitted electronic trade confirmation with the modified execution price.

Modified execution prices associated with respective trades may be determined by the system and transmitted in real-time, or near real-time (such as on a t+1 basis, for example) downstream to beneficial owners and/or to buy-side managers representing beneficial owners so the applicable fee/rebate on which the price modification is based can be accounted for and allocated to beneficial owners at that time. During a trading period, payments received from the buy-side managers (who buy a financial product on behalf of the beneficial owners) and payments sent to buy-side managers (who sell a financial product on behalf of the beneficial owners) for trades executed during the trading period are made on a t+3 basis (i.e., after clearing). The payments made and received by the venue member are based on the modified execution prices rather than the execution prices and are accrued by the venue member over the trading period. As such, when the venue member receives notice of an aggregate fee/rebate applied by the trading venue after the trading period, the venue member balances the aggregate fee/rebate and the execution prices of the trades executed during the trading period against the accrued payments.

Where commissions are applied by the venue member that are payable by the buy-side manager, payments received from the buy-side manager may include the commission amounts. As such, the balancing includes balancing the accrued payments, less the commission amounts, against the aggregate fee/rebate and the execution price of the trades.

The above-described process may be applied for determining a modified execution price for a trade based on a fee/rebate that is applicable on an asymmetrical basis (i.e. a fee or a rebate depending on whether maker or taker) or on a symmetrical basis (i.e. a fee or a rebate, most typically a fee, for both maker and taker).

Furthermore, the process may be executed in real-time as electronic trade confirmation reports are received, or periodically such as daily or several times per day on batches of electronic trade confirmations received.

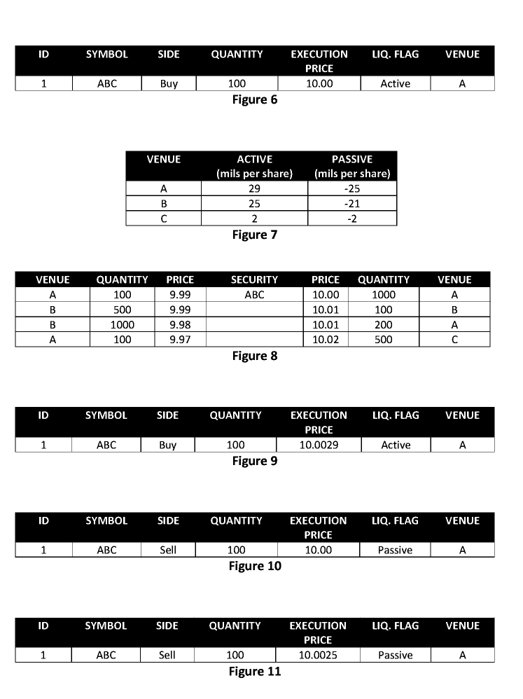

An example of a computer implemented method for determining a modified execution price for a trade and associating the modified execution price with the trade will now be described with reference to FIGS. 6 through 11. FIG. 6 is a representation of an electronic trade confirmation report produced by a trading venue A for a liquidity-taker (Active) buyer of a financial product identified by symbol ABC. The electronic trade confirmation report has an execution price (per share, or “average” price) of 10.00, and a quantity of 100. The ID of the trade is 1.

FIG. 7 is a representation of an electronic pricing schedule with consolidated trading venue pricing for each of trading venues A, B and C, and respective fees/rebates for liquidity-takers and liquidity-makers. It can be seen that each of the venues A, B and C employ a make/take pricing structure where the liquidity maker receives a rebate (negative value) and the liquidity-taker is charged a fee (positive value). The fees and rebates are expressed in mils ( 1/100 of a cent) and on a per-share basis.

FIG. 8 is a representation of a consolidated order book incorporating orders from order books of venues A, B and C. FIG. 9 is a representation of a modified electronic trade confirmation report produced for the liquidity-taker buyer and incorporating a modified execution price in lieu of the execution price. The modified execution price is based on the execution price of the electronic trade confirmation report of FIG. 6 and the applicable fee/rebate. The applicable fee/rebate in this case is determined from the “Active” column and Venue A row in the table of FIG. 6, as 29 mils, or 0.0029 cents. Because the electronic trade confirmation of FIG. 6 was produced for the buyer, the execution price and the applicable fee/rebate (a fee and therefore a positive number) are added together, to result in a modified execution price of 10.0029.

FIG. 10 is a representation of an electronic trade confirmation report produced by the trading venue for a liquidity-maker seller (Passive), according to an embodiment.

FIG. 11 is a representation of a modified trade confirmation report produced for the liquidity-maker seller and incorporating a modified execution price in lieu of the execution price. The modified execution price is based on the execution price of the electronic trade confirmation report of FIG. 10 and the applicable fee/rebate. The applicable fee/rebate in this case is determined from the “Passive” column and Venue A row in the table of FIG. 7, as −25 mils, or −0.0025 cents. Because the electronic trade confirmation report of FIG. 10 was produced for the seller, the applicable fee/rebate (a rebate and thus a negative number) is subtracted from the execution price, to result in a modified execution price of 10.0025.

Although embodiments have been described with reference to the drawings, those of skill in the art will appreciate that variations and modifications may be made without departing from the spirit, scope and purpose of the invention as defined by the appended claims.

For example, while messages and fields formatted according to FIX protocol version 4.2 have been described herein, it will be understood that the particular messages and fields have been chosen for illustrative purposes, and that alternative protocols and message formats may be employed in various systems. Furthermore, it will be understood that a particular system receiving a message formatted according to a particular protocol may convert the message into another protocol for its own use or for use by a downstream system.

While embodiments described have included incorporation of the modified execution price into the modified trade confirmation report in lieu of the execution price, alternatives are contemplated. For example, the modified execution price could be incorporated in the modified electronic trade confirmation in addition to the execution price. Such a format of modified electronic trade confirmation may require basic additional logic on the part of the downstream system such as the buy-side manager in order to use the provided data to allocate the trading venue fee/rebate applicable to the trades to respective beneficial owners.

For example, if the modified execution price is in the execution price field, and the execution price is itself positioned in another field in the modified electronic trade confirmation report, then the downstream system simply processes the modified execution price as it had processed the execution price with no adjustments, thereby automatically allocating each fee/rebate to a respective beneficial owner via the modified execution price. However, if the modified execution price is positioned in a field other than the execution price field, the downstream system will have to be modified to process each modified execution price rather than each execution price in order to allocate the fee/rebate to the beneficial owner via the modified execution price. As will be understood, the advantage of putting modified execution prices in the execution price positions of respective modified electronic trade confirmation reports is that the downstream system does not have to be modified to have the fees/rebates automatically allocated to the beneficial owners.

While embodiments have been described that involve producing a modified electronic trade confirmation report that incorporates the modified execution price, alternatives are contemplated. For example, associating the modified execution price with the trade may include associating the modified execution price with the electronic trade confirmation report, without necessarily producing a modified trade confirmation report.

In such an embodiment, the modified execution price may be stored electronically in a database table along with only a trade identifier that is in common with, or otherwise indirectly associated with, the trade identifier that is also in the electronic trade confirmation report. The modified execution price and trade identifier may be transmitted as a set to downstream systems that have already received the electronic trade confirmation report in order to update the execution price in the received electronic trade confirmation report with the modified execution price.

In another alternative embodiment, associating the modified execution price with the trade includes associating the modified execution price with an electronic order record corresponding to an order posted by the trading venue that corresponds to the trade by virtue of the trade being the result of matching the posted order with a contra order, without producing a modified electronic trade confirmation report. The modified execution price may stored in association with an electronic order record corresponding to a child order, or stored in association with an electronic order record corresponding to a parent order that is associated with a plurality of electronic order records corresponding to child orders one of which is associated with the electronic trade confirmation report, thereby to associate the modified execution price with the trade. In this alternative, the modified execution price may be stored electronically in a database table in its own record but associated with the electronic trade confirmation report record by sharing a common order identifier.

While embodiments have been described that produce a modified electronic trade confirmation report by copying the electronic trade confirmation report and replacing the execution price in the copy with the modified execution price, alternatives are contemplated. For example, once the electronic trade confirmation report is confirmed as being successfully transmitted downstream, it may be subsequently modified simply by replacing the execution price in the trade confirmation report with the modified execution price in order to produce the modified electronic trade confirmation report. The modified electronic trade confirmation report may then be transmitted downstream in order to be stored in association with the previously-transmitted electronic trade confirmation report or to be used to replace the execution price in the downstream, previously-transmitted report with the modified execution price.

While embodiments have been described in which determining the modified execution price includes calculating a sum or difference of the execution price and the at least one fee/rebate, alternatives are contemplated. For example, in an alternative embodiment, determining the modified execution price includes calculating a sum or difference of the execution price and an estimate of the at least one fee/rebate. The estimate of the at least one fee/rebate may be retrieved from an unofficial set of fees/rebates maintained by a venue member or other downstream system that are estimates of the corresponding official fees/rebates. This may be done in order for the venue member system or other downstream system to determine a reasonable modified execution price in real-time despite it not being certain exactly which fee/rebate will be actually applied by the trading venue at the end of a trading period. The uncertainty may exist because fee/rebate amounts actually applied by the trading venue to trades may depend on aggregate trading volume by the venue member over the whole trading period. As would be understood, this volume is not necessarily precisely known by the venue member or even the trading venue at the time of the actual trade.

In an alternative embodiment, the uncertainty as to which fee/rebate will actually be applied at the end of a trading period by the trading venue may be compensated for by determining the modified execution price for the trade by calculating a sum or difference of the execution price and a portion of the official fee/rebate of the trading venue. The portion may be a set percentage of the official fees/rebates of the trading venue, such as for example 90%.

While embodiments have been described in which an electronic data store includes fees/rebates for multiple trading venues, in an alternative embodiment, multiple electronic data stores may be provided that each include fees/rebates for a single respective trading venue. In this embodiment, the electronic data store from which the fee/rebate is to be retrieved is selected based on the venue of execution attribute of the trade. Other alternatives are possible. For example, fees/rebates for a particular venue may be included in different data stores based on whether they are applicable to liquidity makers or liquidity takers.

While embodiments have been described in which the at least one fee/rebate applicable to the trade is retrieved from an electronic data store based on an association in the data store with the attributes of the trade, alternatives are contemplated. For example, the at least one fee/rebate applicable to the trade may be part of the electronic trade confirmation data produced by the trading venue 12, and incorporated into the electronic trade confirmation report. As another example, in an alternative embodiment, determining the at least one fee/rebate based on one or more attributes of the trade may include providing as input to a software module one or more attributes of the trade and receiving the at least one fee/rebate as output from the software module in response to the one or more attributes of the trade. The software module may have computer-readable program code that is “hardcoded” with one or more tables or arrays with the at least one fee/rebate in association with the one or more attributes of the trade.

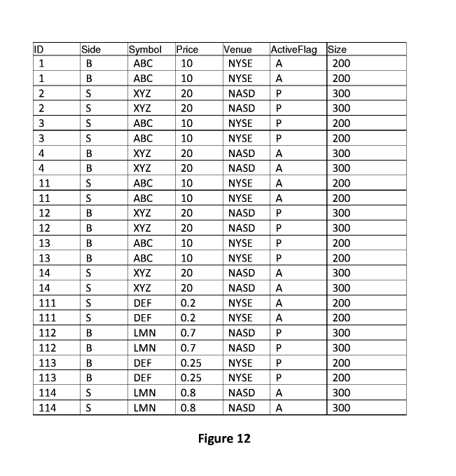

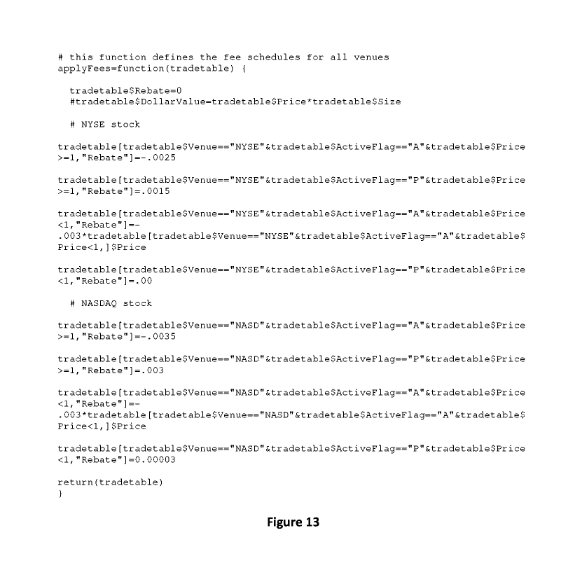

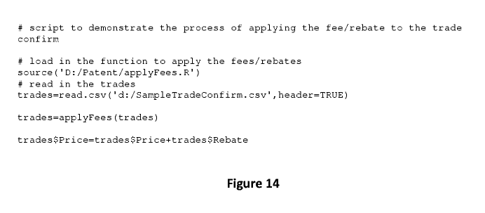

For example, FIG. 12 depicts a table having multiple electronic trade confirmation report records that can be processed by such a software module either in batches or individually. FIG. 13 lists computer-readable program code that is storable in a non-transitory computer-readable medium establishing a function having hardcoded example fee schedules for two different trading venues, namely the New York Stock Exchange (NYSE) and the National Association of Securities Dealers Automated Quotations (NASDAQ abbreviated to NASD). The function of FIG. 13 is capable of receiving a table of electronic trade confirmation report records such as is depicted in FIG. 12, and determining fee/rebates based on the Size of the trade and the Rebate amount specified in the function. FIG. 14 lists computer-readable program code that is storable in a non-transitory computer-readable medium establishing a function for retrieving a .csv file containing the electronic trade confirmation report records depicted in FIG. 12, securing the applicable fee/rebates using the function of FIG. 13, and calculating the modified execution prices for the respective trades based on the Price and the applicable fee/rebate. With the code of FIGS. 13 and 14, the multiple electronic trade confirmation report records of FIG. 12 are processed in batches. It can be seen by the example of FIG. 13 that the trading venue fee/rebate may be applied in a different manner should the execution price be under (or over) a threshold amount. In this case, for example, when the execution price is below $1.00 for NYSE trades, the Active side fee/rebate is calculated using basis points instead of simply the execution price.

While examples herein involve trades of equities, the principles and concepts described herein are applicable to trades of various kinds of financial instruments, such as other equities, exchange-traded funds (ETFs), exchange-traded notes (ETNs), debentures, options, warrants, futures, fixed income, currencies, SWAPs and other instruments.

What is claimed is:

1. A computer-implemented method for processing electronic trade confirmation data generated by at least a first server computer upon execution of a trade in a data processing system comprising at least a second specifically programmed server computer coupled over a communications network to the first server computer, the method comprising:
using the second server computer, determining an execution price from the electronic trade confirmation data generated by the first server computer;
using the second server computer, determining at least one fee/rebate for a side of the trade;
using the second server computer, determining a modified execution price for the side of the trade based at least on the execution price and the at least one fee/rebate; and
using the second server computer, associating the modified execution price with the trade in data store stored on a persistent memory accessible by the second server computer.

2. The computer-implemented method of claim 1, wherein the at least one fee/rebate is applied by a computer associated with a trading venue.

3. The computer-implemented method of claim 2 further comprising, using the second server, determining a side of the trade and the trading venue from the electronic trade confirmation data.

4. The computer-implemented method of claim 1 further comprising, using the second server computer, determining the electronic trade confirmation data from an electronic trade confirmation report.

5. The computer-implemented method of claim 4, wherein associating the modified execution price with the trade comprises:
using the second server computer, producing a modified electronic trade confirmation report incorporating the modified execution price.

6. The computer-implemented method of claim 5, wherein the modified execution price is incorporated in the modified electronic trade confirmation report in lieu of the execution price.

7. The computer-implemented method of claim 6, wherein the modified execution price is incorporated in the execution price field of the modified electronic trade confirmation report.

8. The computer-implemented method of claim 5, wherein the modified execution price is incorporated in the modified electronic trade confirmation report in addition to the execution price.

9. The computer-implemented method of claim 1, wherein associating the modified execution price with the trade comprises associating the modified execution price with the electronic trade confirmation data.

10. The computer-implemented method of claim 9, wherein associating the modified execution price with the electronic trade confirmation data comprises incorporating the modified execution price into an electronic trade confirmation report.

11. The computer-implemented method of claim 1, wherein associating the modified execution price with the trade comprises associating the modified execution price with an order corresponding to the trade.

12. The computer-implemented method of claim 11, wherein storing the modified execution price in association with an order corresponding to the trade comprises storing the modified execution price in association with an electronic order record.

13. The computer-implemented method of claim 1, further comprising:
using the second server computer, determining at least one additional price modifier applicable to the trade; and
using the second server computer, determining the modified execution price based also on the at least one additional price modifier.

14. The computer-implemented method of claim 13, wherein the at least one additional price modifier comprises a charge selected from the group consisting of: a market data fee, a regulatory monitoring fee, a clearing fee, a connectivity fee, and a tax.

15. The computer-implemented method of claim 1, wherein determining at least one fee/rebate applicable to the trade comprises determining multiple fees/rebates applicable to the trade, and calculating the modified execution price is based on the execution price and at least some of the multiple fees/rebates.

16. The computer-implemented method of claim 1, wherein the at least one fee/rebate applicable to the trade comprises a trading venue fee/rebate.

17. The computer-implemented method of claim 1, further comprising:
using the second server computer, during a billing period, accruing payments based on modified execution prices that are received from, or sent to, beneficial owners for trades executed; and
using the second server computer, after the billing period, balancing the accrued payments against an aggregate fee/rebate applied by the trading venue and the execution prices of trades executed during the trading period.

18. The computer-implemented method of claim 1, further comprising:
using the second server computer, transmitting the modified execution price to at least one downstream system in association with the trade.

19. The computer-implemented method of claim 5, further comprising:
using the second server computer, storing the modified electronic trade confirmation report.

20. The computer-implemented method of claim 1, wherein determining at least one fee/rebate comprises determining whether there is a fee/rebate applicable to the trade.

21. The computer-implemented method of claim 20, further comprising:
using the second server computer, in the event that there is no fee/rebate applicable to the trade, determining the modified execution price as equal to the execution price.

22. The computer-implemented method of claim 1, wherein the modified execution price is determined to be equal to the execution price.

23. The computer-implemented method of claim 4, further comprising:
using the second server computer, transmitting the electronic trade confirmation report to at least one downstream system; and
using the second server computer, pursuant to transmitting the electronic trade confirmation report to the at least one downstream system, transmitting the modified execution price to the at least one downstream system for updating the previously-transmitted electronic trade confirmation report.

24. The computer-implemented method of claim 23, wherein the modified execution price is incorporated in a modified electronic trade confirmation report.

25. The computer-implemented method of claim 4, wherein determining the at least one fee/rebate comprises:
determining one or more attributes of the trade from the electronic trade confirmation report; and
determining the at least one fee/rebate based on the one or more attributes of the trade.

26. The computer-implemented method of claim 25, wherein determining the at least one fee/rebate based on one or more attributes of the trade comprises:
providing as input to a software module one or more attributes of the trade; and
receiving the at least one fee/rebate as output from the software module in response to the one or more attributes of the trade.

27. The computer-implemented method of claim 25, wherein determining the at least one fee/rebate based on one or more attributes of the trade comprises:
retrieving, from an electronic data store, the at least one fee/rebate stored in association with one or more attributes of the trade.

28. The computer-implemented method of claim 25, wherein the one or more attributes of the trade comprise a venue of execution identifying the trading venue.

29. The computer-implemented method of claim 26, comprising:
using the second server computer, selecting the electronic data store from a plurality of electronic data stores based at least on one or more attributes of the trade.

30. The computer-implemented method of claim 26, comprising:
using the second server computer, retrieving the at least one fee/rebate in the electronic data store based at least on its association with one or more attributes of the trade.

31. The computer-implemented method of claim 25, wherein one or more attributes of the trade comprises at least one liquidity indicator.

32. The computer-implemented method of claim 31, wherein in the event that the at least one liquidity indicator indicates that neither active nor passive, determining the at least one fee/rebate applicable to the trade to be a default amount.

33. The computer-implemented method of claim 26, wherein the electronic data store is selected from the group consisting of a table, an array, a database, a structured data file, and an XML file.

34. A non-transitory computer readable medium embodying a computer program executable on a computing system for processing electronic trade confirmation data upon execution of a trade, the computer program comprising:
computer program code for determining an execution price from the electronic trade confirmation data;
computer program code for determining at least one fee/rebate for a side of the trade;
computer program code for determining a modified execution price for the side of the trade based at least on the execution price and the at least one fee/rebate; and
computer program code for associating the modified execution price with the trade.

35. A computing system comprising at least one processor executing instructions for processing electronic trade confirmation data upon execution of a trade, the at least one processor configured therewith to determine an execution price and associate with the trade a modified execution price determined based on the execution price and at least one fee/rebate applicable to the trade.
